(19) United States
(12) Patent Application Publication
(10) Pub. No.: US 2012/0005653 A1
(43) Pub. Date: Jan. 5, 2012

(54) CORRELATING SOFTWARE MANAGEMENT FACILITY DATA WITH PRODUCT INVENTORY DATA

(75) Inventor: Mark David Presland, Murdoch (AU)

(73) Assignee: International Business Machines Corporation, Armonk, NY (US)

(21) Appl. No.: 12/828,826

(22) Filed: Jul. 1, 2010

(51) Int. Cl. G06F 9/44

(52) U.S. Cl. 717/120

(57) ABSTRACT

An approach is provided that retrieves aggregate usage data from a storage media, with the aggregate usage data including a number of system management facility records that were previously gathered by a usage monitor that is running on the computer system. A list of a number of loadable software programs that are executable from the computer system is also gathered. The aggregate usage data and the list of loadable software programs are then correlated, with the correlation resulting in a software usage analysis.

### BACKGROUND

Managing software upgrades on many computer systems can be difficult. This difficulty is increased when the software is shared by many users and business units. While management of software upgrades is improved when administrators can identify who is using the software and where on the system the software resides, this information often difficult to gather.

### SUMMARY

An approach is disclosed that retrieves aggregate usage data from a storage media, with the aggregate usage data including a number of system management facility records that were previously gathered by a usage monitor that is running on the computer system. A list of a number of loadable software programs that are executable from the computer system is also gathered. The aggregate usage data and the list of loadable software programs are then correlated, with the correlation resulting in a software usage analysis.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 is a network diagram of various types of data processing systems connected via a computer network;

FIG. 3 is an exemplary diagram showing various types of data being correlated to create usage analysis data;

FIG. 4 is an exemplary flowchart diagram showing steps taken to analyze software usage on a shared computer system;

FIG. 5 is an exemplary flowchart diagram showing steps taken to process System Management Facility (SMF) records;

FIG. 6 is an exemplary flowchart diagram showing the steps taken to process system inquisitor (IQ) data;

FIG. 7 is an exemplary flowchart diagram showing the steps taken to correlate data; and

FIG. 8 is an exemplary flowchart diagram showing steps taken to write universal monitoring (UM) output useful in analyzing software usage.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

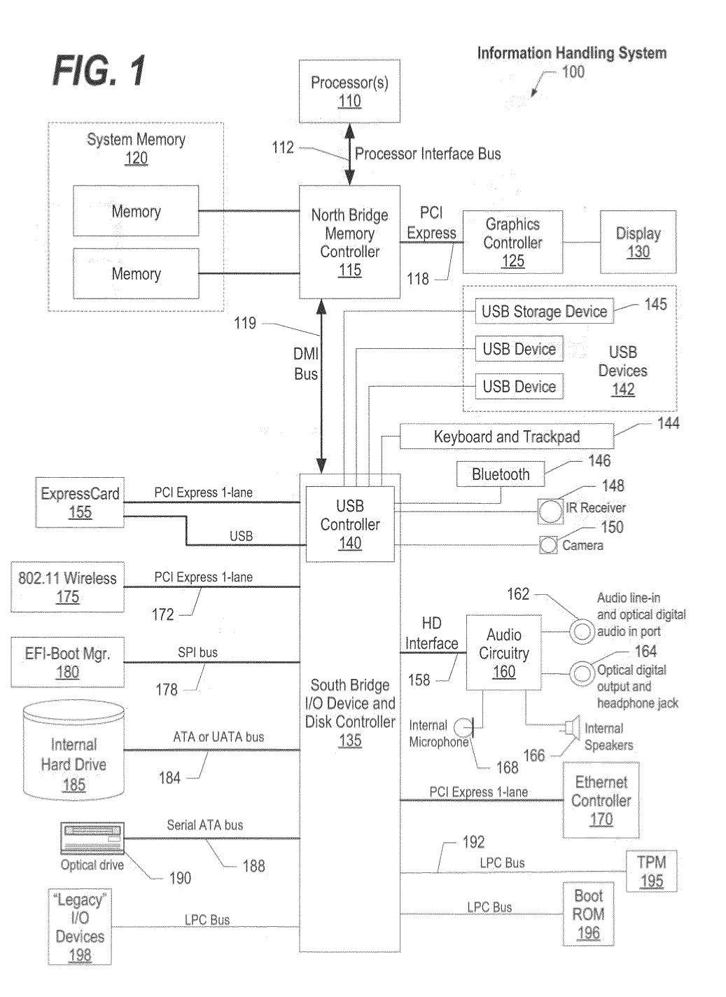

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANS). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

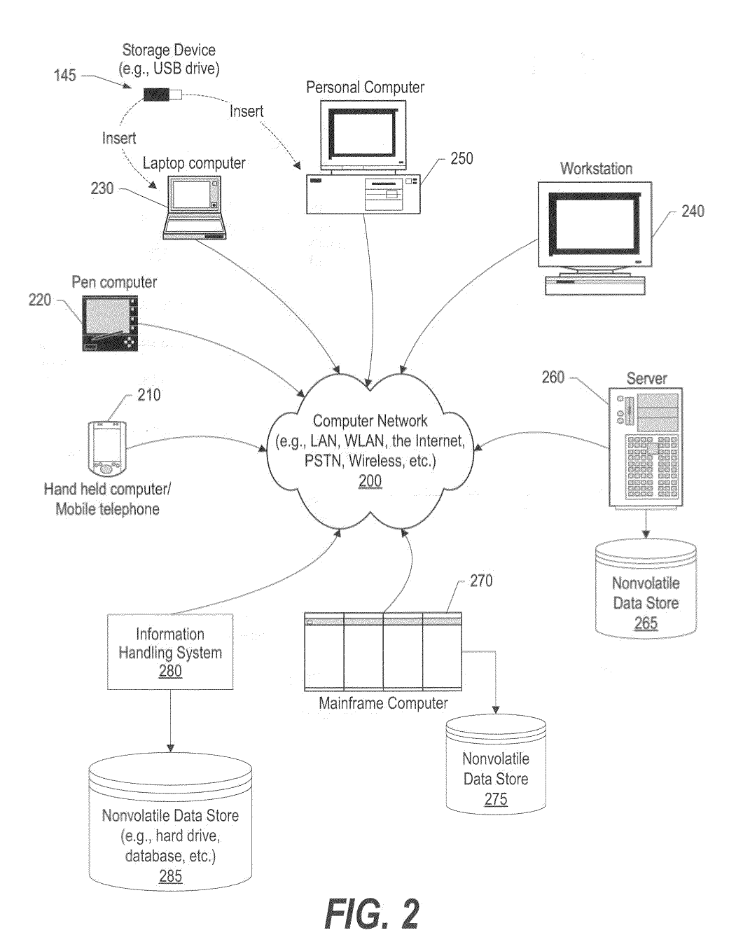

FIG. 2 is a network diagram of various types of data processing systems connected via a computer network. FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

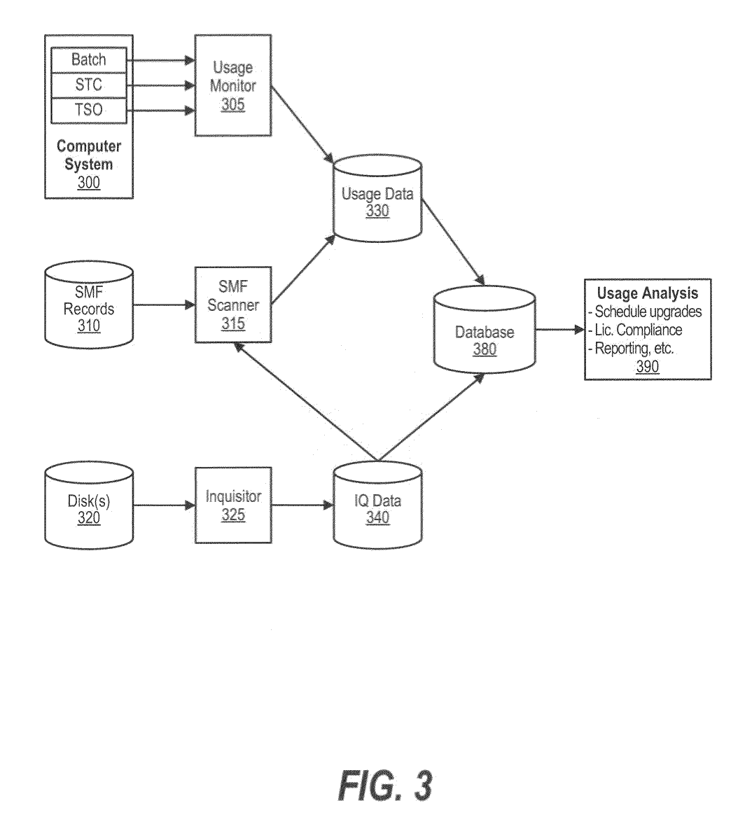

FIG. 3 is an exemplary diagram showing various types of data being correlated to create usage analysis data. Computer system 300 includes various types of mainframe operations, such as Time Sharing Option (TSO), batch jobs, and the like. Usage monitor 305 monitors usage of computer system 300 and records usage data in usage data store 330. In addition, a system management facility is a component of the mainframe operating system and provides a standardized method of writing activity records to SMF records 310. In one embodiment, SMF provides reporting of all baseline activities running on computer system 300's operating system, including I/O activity, network activity, software usage, error conditions, processor utilization, and the like. SMF data included in SMF records 310 includes adequate job usage data, however the SMF data does not include data pertaining to which datasets are being used to access the load modules. However, the SMF data does contain EXCP (execute channel program) statistics for each Job Step DD (data definition) per volume. In addition, in one embodiment, the mainframe operating system (e.g., z/OS®) loads EXEC PGM modules based on a search sequence of (1) STEPLIB DD or JOBLIB DD (when no STEPLIB DD is provided), (2) LPA (link pack area), and (3) LINKLST (which usually includes a list of libraries).

Most product maintenance is installed on fresh (e.g., previously unused volumes, so in most cases the modules are in one dataset per volume. Therefore, correlating the volumes in the EXCP statistics against a Product Inventory, the dataset name being accessed can usually be derived. In FIG. 3, disk(s) 320 included in computer system 300 are inventoried using Inquisitor software program 325 which results in inquisitor (IQ) data 340 which is a Product Inventory of the software products residing on computer system 300. IQ data 340 includes a list of loadable software programs available on computer system 300. Usage data 330 and the list of loadable software programs from IQ data 340 are correlated into database 380 which is a cache of usage analysis data. Process 390 performs a usage analysis using the usage analysis data. A usage analysis can include upgrade schedules that inform administrators when software can be upgraded, license compliance reports that show what licensed software is being used by which users, and other general usage analysis reporting.

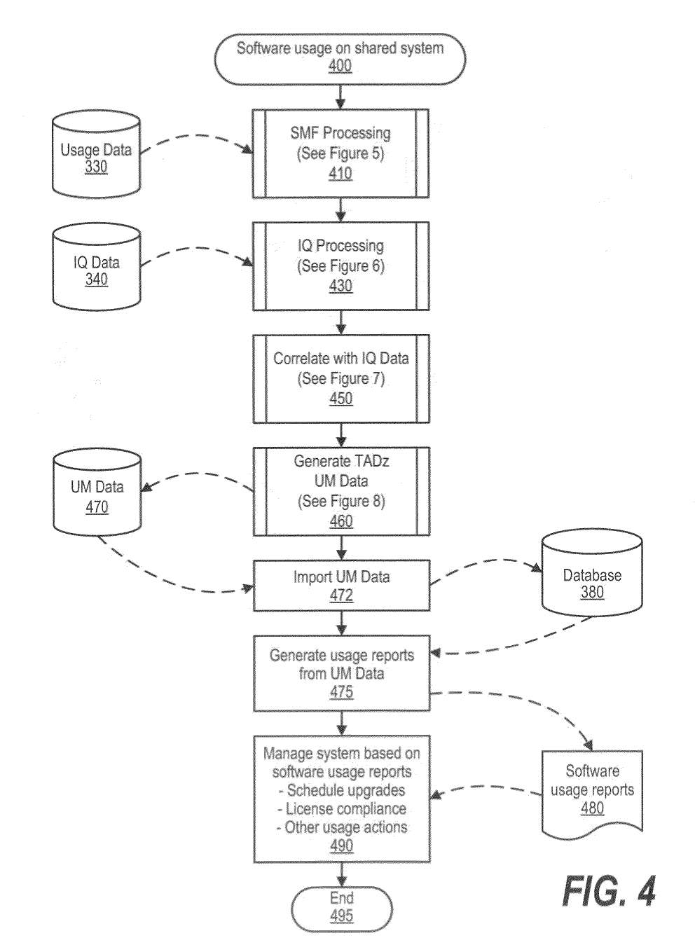

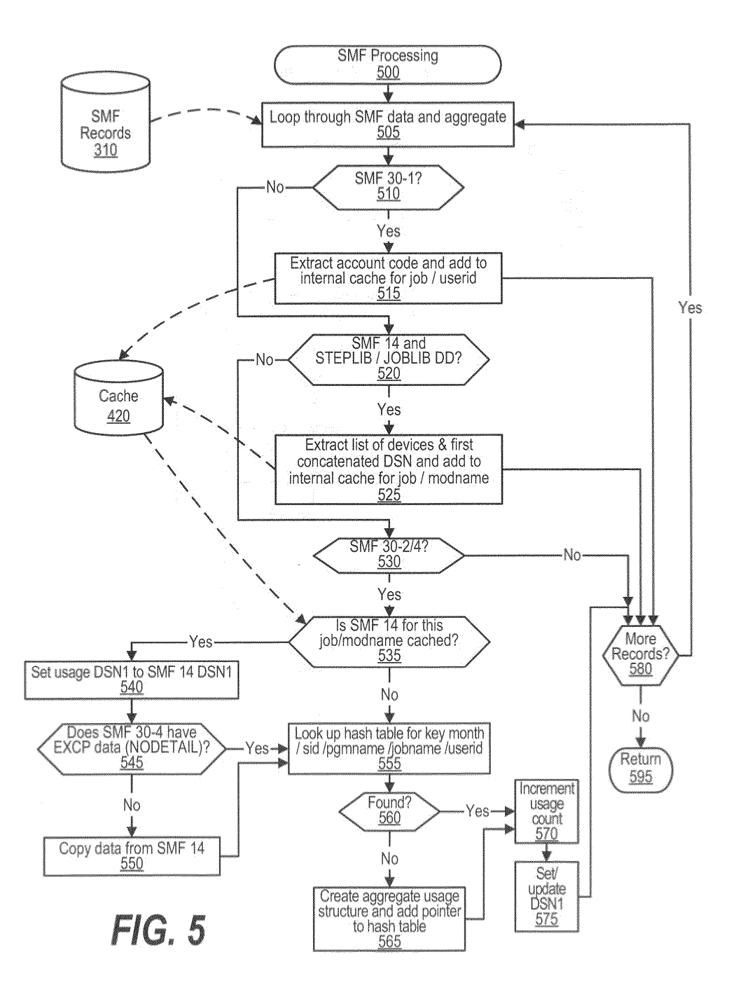

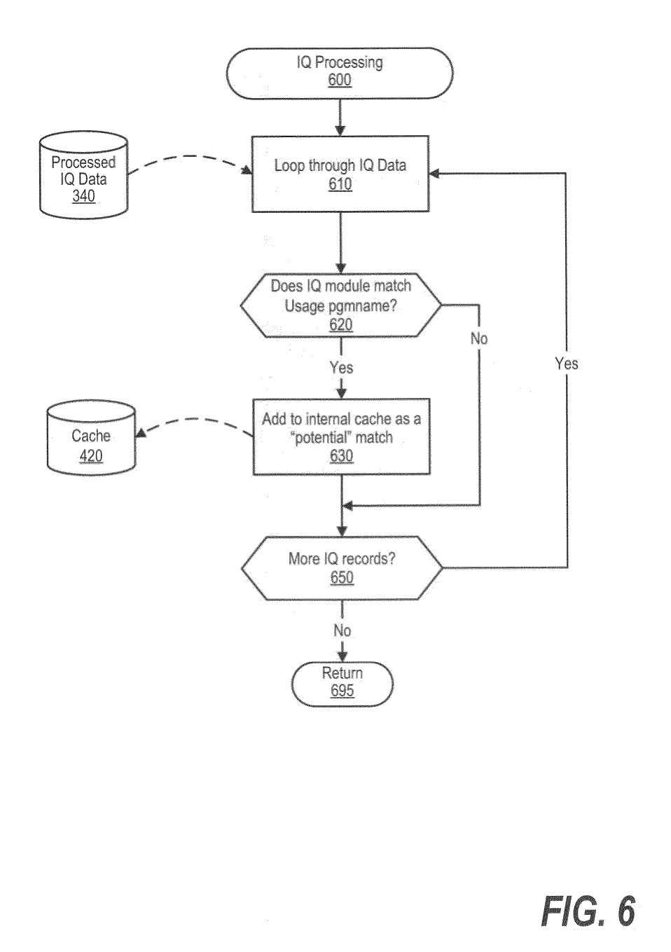

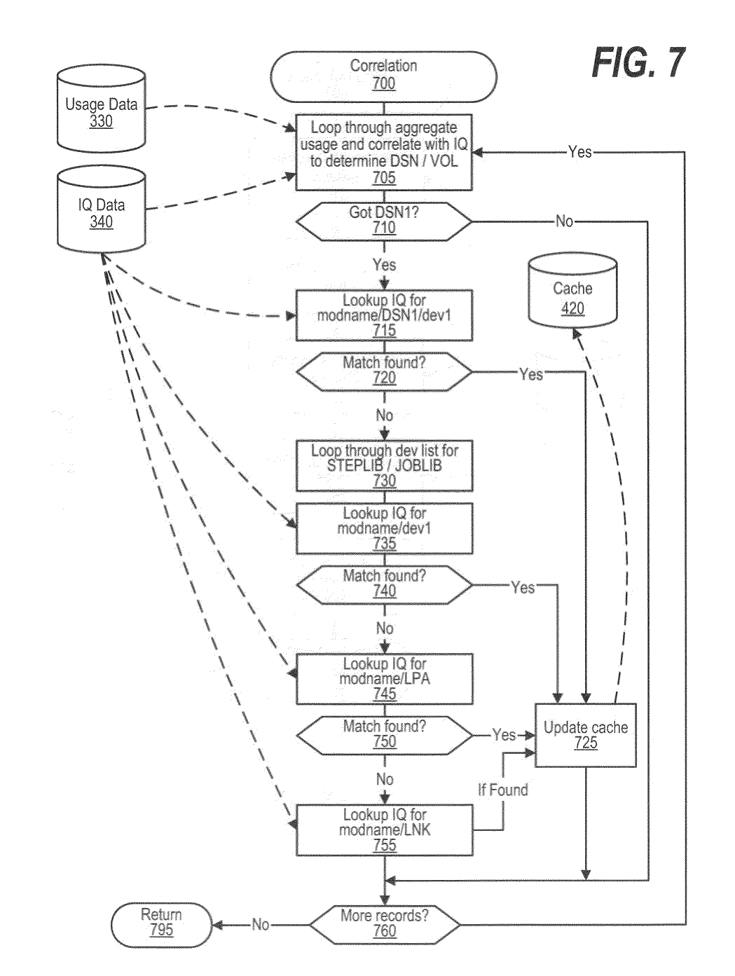

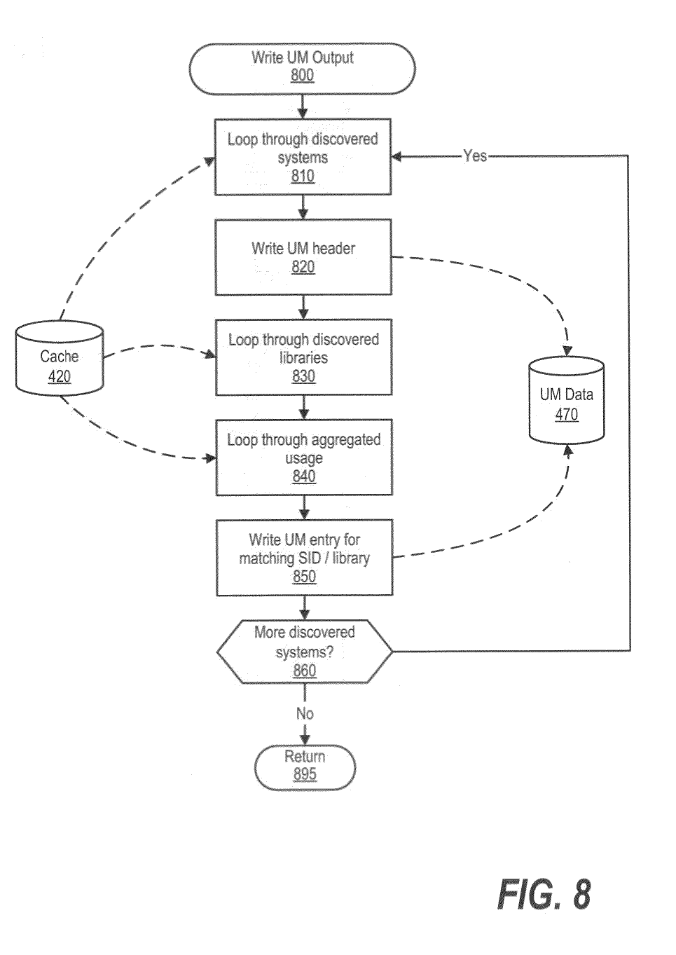

FIG. 4 is an exemplary flowchart diagram showing steps taken to analyze software usage on a shared computer system. Processing commences at 400 whereupon, at predefined process 410, processing of the system management facility (SMF) records that were collected by the usage monitor is performed using usage data 330 as an input (see FIG. 5 and corresponding text for processing details). At predefined process 430, Product Inventory data is processed in order to gather a list of loadable software programs that are executable from the computer system (see FIG. 6 and corresponding text for processing details). At predefined process 450, the processed SMF records are correlated with the gathered list of loadable software programs that are executable from the computer system (see FIG. 7 and corresponding text for processing details). At predefined process 460, TADz UM data is generated (see FIG. 8 and corresponding text for processing details. This results in UM data store 470. At step 472, UM data is imported from UM data store 470 and loaded into database 380. At step 475, various software usage analysis, such as reports and the like, are generated using the data stored in database 380. The result of step 475 are one or more software usage reports 480. At step 490, system administrators use the usage analysis information in order to manage the computer system. Management of the computer system includes scheduling upgrades, ensuring that the organization is complying with software licensing provisions, as well as other software usage actions. Processing shown in FIG. 4 thereafter ends at 495.

FIG. 5 is an exemplary flowchart diagram showing steps taken to process System Management Facility (SMF) records. Processing commences at 500 whereupon, at step 505, the process loops through SMF records stored in SMF records data store 310 and aggregates the data. A decision is made as to whether the selected record is an SMF record of type 30, subtype 1 (decision 510). SMF type 30 records are common address space work records that include job activity information, including the job name, user identifier, and EXEC PGM module name. However, SMF type 30 records do not include information pertaining to the product that the module is a part of nor do these records include the dataset from which the module was accessed. Subtype 1 indicates that the record corresponds to a job or task initiation. If the selected SMF record is type 30, subtype 1, then decision 510 branches to the “yes” branch whereupon, at step 515, the account code included in the record is extracted and added to internal cache 420 for the job and the user identifier. Processing then goes to decision block 580 to determine if there are more SMF records to process. If there are more records to process, then decision 580 branches to the “yes” branch which loops back to select the next SMF record at step 505, while if there are no more SMF records to process, then decision 580 branches to the “no” branch and processing shown in FIG. 5 returns to the calling routine at 595. Returning to decision 510, if the selected SMF record is not type 30 and subtype 1, then decision 510 branches to the “no” branch and processing of the record continues.

A decision is made as to whether the selected SMF record is a type 14 record and either a STEPLIB or JOBLIB (STEPLIB/JOBLIB) data definition (DD) statement (decision 520). If the selected SMF record is a type 14 record and either a STEPLIB/JOBLIB data definition statement, then decision 520 branches to the “yes” branch whereupon, at step 525, processing extracts a list of devices and the first concatenated data set name (DSN) and adds the information to the internal cache (420) for the job and the module name. Processing then goes to decision block 580 to determine if there are more SMF records to process. If there are more records to process, then decision 580 branches to the “yes” branch which loops back to select the next SMF record at step 505, while if there are no more SMF records to process, then decision 580 branches to the “no” branch and processing shown in FIG. 5 returns to the calling routine at 595. Returning to decision 520, if the selected SMF record is not is a type 14 record or there is not a STEPLIB/JOBLIB data definition statement, then decision 520 branches to the “no” branch and processing of the record continues.

A decision is made as to whether the selected SMF record is a type 30 record and either a subtype of 2 or 4 (decision 530). As previously described, a type 30 record corresponds to common address space work that include records of job activity. Subtype 2 records correspond to interval termination activity while subtype 4 records correspond to step termination activity. If the selected record is not a type 30 record with a subtype of either 2 or 4, then decision 530 branches to the “no” branch whereupon processing goes to decision block 580 to determine if there are more SMF records to process. If there are more records to process, then decision 580 branches to the “yes” branch which loops back to select the next SMF record at step 505, while if there are no more SMF records to process, then decision 580 branches to the “no” branch and processing shown in FIG. 5 returns to the calling routine at 595. If the selected record is a type 30 record and either a subtype of 2 or 4, then processing continues as described below.

A decision is made as to whether there is an SMF type 14 record that was cached in cache 420 for this job or module name (decision 535). If there is an SMF type 14 record that was cached in cache 420 for this job or module name, then decision 535 branches to the “yes” branch whereupon, at step 540, the usage data set name (DSN1) is set to the data set name (DSN1) found in the SMF type 14 record. A decision is made as to whether an SMF type 30, subtype 4 record has execute channel program (EXCP) data included (decision 545). If the selected SMF record is not a type 30, subtype 4 record or if the SMF record does not includes EXCP data, then decision 545 branches to the “no” branch, whereupon, at step 550, the needed data is copied from the SMF type 14 record that was cached into cache 420. On the other hand, if the SMF record a type 30, subtype 4 record that includes EXCP data, then decision 545 branches to the “yes” branch bypassing step 550. Regardless of which branch was taken from decision 545, at step 555, a lookup is performed on a hash table for various keys such as month, session identifier (sid), program name (pgmname), job name, and user identifier (userid). A decision is made as to whether a record was found in the hash table (decision 560). If a record was not found, then decision 560 branches to the “no” branch whereupon, at step 565, an aggregate usage structure is created and a pointer is added to the hash table that points to the aggregate usage structure. On the other hand, if a hash entry was found, then decision 560 branches to the “yes” branch bypassing step 565 since the aggregate usage structure already exists. At step 570, regardless of which branch was taken from decision 560, the usage count included in the aggregate usage structure is incremented. At step 575, the data set name (DSN1) is either set or updated depending upon whether the aggregate usage structure already existed or has just been created. Processing then goes to decision block 580 to determine if there are more SMF records to process. If there are more records to process, then decision 580 branches to the “yes” branch which loops back to select the next SMF record at step 505, while if there are no more SMF records to process, then decision 580 branches to the “no” branch and processing shown in FIG. 5 returns to the calling routine at 595.

FIG. 6 is an exemplary flowchart diagram showing the steps taken to process system inquisitor (IQ) data. Processing commences at 600 whereupon, at step 610, processing loops through system inquisitor (IQ) data stored in IQ data store 340. As previously described, IQ data 340 includes a list of loadable software programs that are executable from the computer system. A decision is made as to whether the record from the IQ data matches a usage program name (decision 620). If the record matches a usage program name, then decision 620 branches to the “yes” branch whereupon, at step 630, the program name and associated data is added to internal cache 420 as a potential match. On the other hand, if the IQ module does not match a usage program name, then decision 620 branches to the “no” branch bypassing step 630.

A decision is made as to whether there are more records from IQ data store 340 to process (decision 650). If there are more IQ records to process, then decision 650 branches to the “yes” branch which loops back to select and process the next record from data store 340. This looping continues until all of the records in IQ data store 340 have been processed, at which point decision 650 branches to the “no” branch and processing returns to the calling routine at 695 (see FIG. 4).

FIG. 7 is an exemplary flowchart diagram showing the steps taken to correlate data. Correlation processing commences at 700 whereupon, at step 705, processing loops through usage data stored in usage data store 330 and correlates the records with data stored in IQ data store 340. As previously described, IQ data store 340 includes a list of a plurality of loadable software programs that are executable from the computer system. A decision is made as to whether the data set name (DSN1) has been retrieved (decision 710). If the data set name has not been retrieved, then decision 710 branches to the “no” branch which bypasses the remaining processing for the record and goes to decision 760 which determines whether there are more records to process. If there are more records to process, decision 760 branches to the “yes” branch which loops back to select the next record from usage data store 330 and attempt to correlate it. This looping continues until all of the usage data records have been processed, at which time decision 760 branches to the “no” branch and processing returns to the calling routine (see FIG. 4) at 795.

Returning to decision 710, if the data set name has been retrieved for the usage data record, then decision 710 branches to the “yes” branch whereupon, at step 715, processing looks up the module name (modname/DSN1/dev1) from IQ data store 340. A decision is made as to whether a match was found in IQ data store 340. If a match was found, then decision 720 branches to the “yes” branch whereupon, at step 725, the cache (cache 420) is updated with the module name found in IQ data store 340, and step 725 goes to decision 760 which determines whether there are more records to process. If there are more records to process, decision 760 branches to the “yes” branch which loops back to select the next record from usage data store 330 and attempt to correlate it. This looping continues until all of the usage data records have been processed, at which time decision 760 branches to the “no” branch and processing returns to the calling routine (see FIG. 4) at 795.

Returning to decision 720, if a match was not found in the IQ data store, then decision 720 branches to the “no” branch whereupon, at step 730, processing loops through the device list (dev list) for a STEPLIB or JOBLIB statement. At step 735, processing looks up the module name from the IQ data store using the data found in any STEPLIB or JOBLIB DD statement. A decision is made as to whether a match was found (decision 740). If a match was found, then decision 740 branches to the “yes” branch whereupon, at step 725, the cache (cache 420) is updated with the module name found in IQ data store 340, and step 725 goes to decision 760 which determines whether there are more records to process. If there are more records to process, decision 760 branches to the “yes” branch which loops back to select the next record from usage data store 330 and attempt to correlate it. This looping continues until all of the usage data records have been processed, at which time decision 760 branches to the “no” branch and processing returns to the calling routine (see FIG. 4) at 795.

Returning to decision 740, if a match was not found, then decision 740 branches to the “no” branch whereupon, at step 745, processing attempts to find a match based upon the module name and the link pack area (LPA). A decision is made as to whether a match was found in the IQ data store (decision 750). If a match was found, then decision 750 branches to the “yes” branch whereupon, at step 725, the cache (cache 420) is updated with the module name found in IQ data store 340, and step 725 goes to decision 760 which determines whether there are more records to process. If there are more records to process, decision 760 branches to the “yes” branch which loops back to select the next record from usage data store 330 and attempt to correlate it. This looping continues until all of the usage data records have been processed, at which time decision 760 branches to the “no” branch and processing returns to the calling routine (see FIG. 4) at 795.

Returning to decision 750, if a match was not found using the module name in the link pack area (LPA), then decision 750 branches to the “no” branch whereupon, at step 755, processing attempt to find a match in the IQ data store based upon the module name and the link list (LNK). If a match was found, then step 755 branches to step 725 where the cache (cache 420) is updated with the module name found in IQ data store 340, and step 725 goes to decision 760 which determines whether there are more records to process. If there are more records to process, decision 760 branches to the “yes” branch which loops back to select the next record from usage data store 330 and attempt to correlate it. This looping continues until all of the usage data records have been processed, at which time decision 760 branches to the “no” branch and processing returns to the calling routine (see FIG. 4) at 795. If a match was not found in the IQ data store, then step 755 branches to decision 760 which, as described above, determines whether there are more records to process. If there are more records to process, decision 760 branches to the “yes” branch which loops back to select the next record from usage data store 330 and attempt to correlate it. This looping continues until all of the usage data records have been processed, at which time decision 760 branches to the “no” branch and processing returns to the calling routine (see FIG. 4) at 795.

FIG. 8 is an exemplary flowchart diagram showing steps taken to write universal monitoring (UM) output useful in analyzing software usage. Processing commences at 800 whereupon, at step 810, processing loops through discovered systems that have been identified with records stored in cache 420 via the processing shown in FIGS. 4 through 7. At step 820, a UM header is written to UM data store 470. At step 830, processing loops though discovered libraries that have been identified with records stored in cache 420 via the processing shown in FIGS. 4 through 7. At step 840, processing loops through the aggregated usage data that has been identified with records stored in cache 420 via the processing shown in FIGS. 4 through 7. At step 850, a UM entry is written to UM data store 470 for the matching system identifier and library.

A decision is made as to whether there are more discovered systems that have been identified with records stored in cache 420 via the processing shown in FIGS. 4 through 7 (decision 860). If there are additional discovered systems to process, then decision 860 branches to the “yes” branch which loops back to select the next discovered system at step 810 and process it as described above. This looping continues until all of the discovered systems have been processed, at which point decision 860 branches to the “no” branch and processing returns to the calling routine (see FIG. 4) at 895.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer system implemented method comprising:
retrieving aggregate usage data from a storage media, wherein the aggregate usage data includes a plurality of system management facility records gathered by a usage monitor running on the computer system;
gathering a list of a plurality of loadable software programs that are executable from the computer system; and
correlating the aggregate usage data and the list of loadable software programs, the correlating resulting in a software usage analysis.

2. The method of claim 1 wherein the retrieving further comprises:
identifying a plurality of job/task initiation records within the plurality of system management facility records; and
extracting an account code from each of the identified job/task initiation records.

3. The method of claim 1 wherein the retrieving further comprises:
identifying a plurality of input data set activity records within the plurality of system management facility records; and
extracting a list of one or more devices and at least one data set name corresponding to each of the plurality of termination records.

4. The method of claim 1 wherein the retrieving further comprises:
identifying a plurality of interval/step termination records within the plurality of system management facility records;
identifying a cached input data set activity record corresponding to one or more of the identified interval/step termination records; and
setting a usage data set name corresponding to each of the plurality of interval/step termination records with a corresponding cached input data set activity record to a data set name included in the corresponding cached input data set activity record.

5. The method of claim 1 wherein the correlating further comprises:
reading the aggregate usage data that includes the plurality of system management facility records;
retrieving the list of loadable software programs, wherein one or more of the listed loadable software programs include a corresponding data set name; and
including the aggregate usage data and the data set name in a cache that is used as an input to a software usage analysis process.

6. The method of claim 1 wherein the correlating further comprises:
reading the aggregate usage data that includes the plurality of system management facility records;
retrieving the list of loadable software programs, wherein one or more of the listed loadable software programs include a corresponding module name;
matching the one or more of the system management facility records included in the aggregate usage data with one or more module names included in the list of loadable software programs; and
including the aggregate usage data and the matching module name data from the list of loadable software programs in a cache that is used as an input to a software usage analysis process.

7. The method of claim 1 further comprising:
writing a software usage data store, the writing including:
looping through a plurality of discovered systems stored in a cache that resulted from the correlating;
looping through a plurality of discovered libraries stored in the cache;
looping through a plurality of aggregated usage data stored in the cache; and
writing a plurality of entries in the software usage data store, wherein each entry corresponds to a matching system identifier and a matching library name.

8. An information handling system comprising:
one or more processors;
a memory coupled to at least one of the processors;
a set of instructions stored in the memory and executed by at least one of the processors in order to perform actions of:
retrieving aggregate usage data from a storage media, wherein the aggregate usage data includes a plurality of system management facility records gathered by a usage monitor running on the computer system;
gathering a list of a plurality of loadable software programs that are executable from the computer system; and
correlating the aggregate usage data and the list of loadable software programs, the correlating resulting in a software usage analysis.

9. The information handling system of claim 8 wherein the retrieving further comprises actions of:
identifying a plurality of job/task initiation records within the plurality of system management facility records; and
extracting an account code from each of the identified job/task initiation records.

10. The information handling system of claim 8 wherein the retrieving further comprises actions of:
identifying a plurality of input data set activity records within the plurality of system management facility records; and
extracting a list of one or more devices and at least one data set name corresponding to each of the plurality of termination records.

11. The information handling system of claim 8 wherein the retrieving further comprises actions of:
identifying a plurality of interval/step termination records within the plurality of system management facility records;
identifying a cached input data set activity record corresponding to one or more of the identified interval/step termination records; and
setting a usage data set name corresponding to each of the plurality of interval/step termination records with a corresponding cached input data set activity record to a data set name included in the corresponding cached input data set activity record.

12. The information handling system of claim 8 wherein the correlating further comprises actions of:
reading the aggregate usage data that includes the plurality of system management facility records;
retrieving the list of loadable software programs, wherein one or more of the listed loadable software programs include a corresponding data set name; and
including the aggregate usage data and the data set name in a cache that is used as an input to a software usage analysis process.

13. The information handling system of claim 8 wherein the correlating further comprises actions of:
reading the aggregate usage data that includes the plurality of system management facility records;
retrieving the list of loadable software programs, wherein one or more of the listed loadable software programs include a corresponding module name;
matching the one or more of the system management facility records included in the aggregate usage data with one or more module names included in the list of loadable software programs; and
including the aggregate usage data and the matching module name data from the list of loadable software programs in a cache that is used as an input to a software usage analysis process.

14. A computer program product stored in a computer readable medium, comprising functional descriptive material that, when executed by an information handling system, causes the information handling system to perform actions that include:
retrieving aggregate usage data from a storage media, wherein the aggregate usage data includes a plurality of system management facility records gathered by a usage monitor running on the computer system;
gathering a list of a plurality of loadable software programs that are executable from the computer system; and
correlating the aggregate usage data and the list of loadable software programs, the correlating resulting in a software usage analysis.

15. The computer program product of claim 14 wherein the retrieving further comprises actions of:
identifying a plurality of job/task initiation records within the plurality of system management facility records; and
extracting an account code from each of the identified job/task initiation records.

16. The computer program product of claim 14 wherein the retrieving further comprises actions of:
identifying a plurality of input data set activity records within the plurality of system management facility records; and
extracting a list of one or more devices and at least one data set name corresponding to each of the plurality of termination records.

17. The computer program product of claim 14 wherein the retrieving further comprises actions of:
identifying a plurality of interval/step termination records within the plurality of system management facility records;
identifying a cached input data set activity record corresponding to one or more of the identified interval/step termination records; and
setting a usage data set name corresponding to each of the plurality of interval/step termination records with a corresponding cached input data set activity record to a data set name included in the corresponding cached input data set activity record.

18. The computer program product of claim 14 wherein the correlating further comprises actions of:
reading the aggregate usage data that includes the plurality of system management facility records;
retrieving the list of loadable software programs, wherein one or more of the listed loadable software programs include a corresponding data set name; and
including the aggregate usage data and the data set name in a cache that is used as an input to a software usage analysis process.

19. The computer program product of claim 14 wherein the correlating further comprises actions of:
reading the aggregate usage data that includes the plurality of system management facility records;
retrieving the list of loadable software programs, wherein one or more of the listed loadable software programs include a corresponding module name;
matching the one or more of the system management facility records included in the aggregate usage data with one or more module names included in the list of loadable software programs; and
including the aggregate usage data and the matching module name data from the list of loadable software programs in a cache that is used as an input to a software usage analysis process.

20. The computer program product of claim 14 wherein the actions further comprise:
writing a software usage data store, the writing including:
looping through a plurality of discovered systems stored in a cache that resulted from the correlating;
looping through a plurality of discovered libraries stored in the cache;
looping through a plurality of aggregated usage data stored in the cache; and
writing a plurality of entries in the software usage data store, wherein each entry corresponds to a matching system identifier and a matching library name.
